(19) United States
(12) Patent Application Publication
(10) Pub. No.: US 2003/0058248 A1
(43) Pub. Date: Mar. 27, 2003

(54) System and method for communicating graphics over a network

(76) Inventors: Roland M. Hochmuth, Fort Collins, CO (US); John Marks, Fort Collins, CO (US); David John Sweetser, Fort Collins, CO (US)

Correspondence Address: HEWLETT-PACKARD COMPANY, Intellectual Property Administration, P.O. Box 272400, Fort Collins, CO, 80527-2400, US

(21) Appl. No.: 09/960,523

(22) Filed: Sep. 21, 2001

(51) Int. Cl. G06F 13/00; G06F 15/16

(52) U.S. Cl. 345/537; 345/502

(57) ABSTRACT

The present invention is generally directed to a system and method for communicating video across one or more computer networks. Broadly, the system comprises a frame buffer memory for storing and maintaining a previous frame of graphics information, a temporary memory configured to store at least a portion of a current frame of graphics information, comparison logic for comparing a portion of the current frame of graphics information with a corresponding portion of the previous frame, and transmission logic for transmitting the portion of the current frame to a destination computer, if the comparison logic determines that the portion of the current frame of graphics information differs from the corresponding portion of the previous frame by more than a predetermined measure. Similarly, a method is provided that stores a frame of graphics information obtained from a video signal, receives at least a portion of a current frame of graphics information, compares a portion of the current frame of graphics information with a corresponding portion of the stored frame of graphics information. Then, if the compared portion of the current frame of graphics information differs by at least a predetermined amount from the corresponding portion of the stored graphics information, the method transmits the compared portion of the current frame of graphics information to a destination computer and overwrites the corresponding portion of the stored graphics information with the compared portion of the current frame of graphics information.

### BACKGROUND OF THE INVENTION

1. Field of the Invention

The present invention generally relates to networked computer systems, and more particularly to a system and method for communicating graphics over a network.

Discussion of the Related Art As is known, it is often desired to display computer graphics information, that is generated on one computer, on a remote computer display. Sometimes it is desired to provide this type of remote graphics display across a local area network (LAN), and sometimes it is desired to provide this type of remote display across a wide area network (WAN), such as the Internet.

Various approaches have been undertaken to implement this goal. Generalizing, the approaches of prior art systems involve formatting graphics data into an appropriate network protocol and transmitting the data directly from the source computer. One approach involves reading of the frame-buffer back into a system memory, compressing and assembling IP (Internet Protocol) packets, and then sending the IP packets to the destination computer node. Unfortunately, the process of reading the frame-buffer back into system memory and sending the IP packets to the destination computer node involve significant computation in the color space computation/conversion and compression stage, which significantly impact the input/output (I/O) and memory sub-systems, as well as the central processing unit (CPU) and networking sub-system.

Another approach of prior art systems involves the reception or collection of commands and data being sent to, for example, a graphics card. In certain systems this data is collected, and communicated to a remote client. While this approach may be effective to communicate graphics to a remote client, the remote client generally must have all the capabilities to render graphics as the computer sending the commands and data.

Another disadvantage of prior art systems is that they generally require operating system-dependent (OS-dependent) code that operates at the device driver layer, which must be written to control the devices. This OS-dependent code varies from system to system.

A further problem with many prior art systems relates to bandwidth consumption, particularly when communicating graphics information. As is known, when transmitting graphics, successive frames of data may be transmitted every 1/60th of a second (to support a 60 Hz refresh rate), or at some other rate (if other than 60 Hz refresh rate). Transmitting entire frames of graphics information every 1/60th of a second may exceed the bandwidth limitations of many networks, particularly when communicating over a wide area network.

### SUMMARY OF THE INVENTION

The present invention is generally directed to a system and method for communicating graphics across one or more networks. Broadly, the system comprises a frame buffer memory for storing and maintaining a previous frame of graphics information, a temporary memory configured to store at least a portion of a current frame of graphics information, comparison logic for comparing a portion of the current frame of graphics information with a corresponding portion of the previous frame, and transmission logic for transmitting the portion of the current frame to a destination computer, if the comparison logic determines that the portion of the current frame of graphics information differs from the corresponding portion of the previous frame by more than a predetermined measure.

In accordance with another embodiment, a method is provided that stores a frame of graphics information obtained from a video signal, receives at least a portion of a current frame of graphics information, compares a portion of the current frame of graphics information with a corresponding portion of the stored frame of graphics information. Then, if the compared portion of the current frame of graphics information differs by at least a predetermined amount from the corresponding portion of the stored graphics information, the method transmits the compared portion of the current frame of graphics information to a destination computer and overwrites the corresponding portion of the stored graphics information with the compared portion of the current frame of graphics information.

### DESCRIPTION OF THE DRAWINGS

The accompanying drawings incorporated in and forming a part of the specification, illustrate several aspects of the present invention, and together with the description serve to explain the principles of the invention. In the drawings:

FIG. 1 is a block diagram illustrating a system environment for accommodating one embodiment of the invention;

FIG. 2 is a block diagram of a network video apparatus (NVA);

FIG. 3 is a flowchart illustrating the top-level operation of an NVA;

FIG. 4 is a block diagram similar to FIG. 1, but illustrating an alternative system configuration;

FIG. 5 is a block diagram, similar to the diagram of FIG. 2, but illustrating components of a NVA constructed in accordance with the embodiment illustrated in FIG. 4;

FIG. 6 is a block diagram similar to FIG. 1, but illustrating a system constructed in accordance with another embodiment;

FIG. 7 is a block diagram illustrating a system constructed in accordance with one embodiment of the present invention;

FIG. 8 is a flowchart illustrating the top-level operation of an NVA in accordance with one embodiment of the invention;

FIG. 9 is a flowchart illustrating the top-level operation of a destination computer constructed in accordance with one embodiment of the invention;

FIG. 10 is a block diagram illustrating certain components of an NVA constructed in accordance with an embodiment of the invention;

FIG. 11 is block diagram illustrating certain components of a destination computer constructed to receive graphics information from an NVA constructed in accordance with one embodiment of the invention; and

FIG. 12 is a flowchart illustrating the top-level operation of an NVA constructed in accordance with an alternative embodiment of the invention.

### DETAILED DESCRIPTION OF THE PREFERRED EMBODIMENT

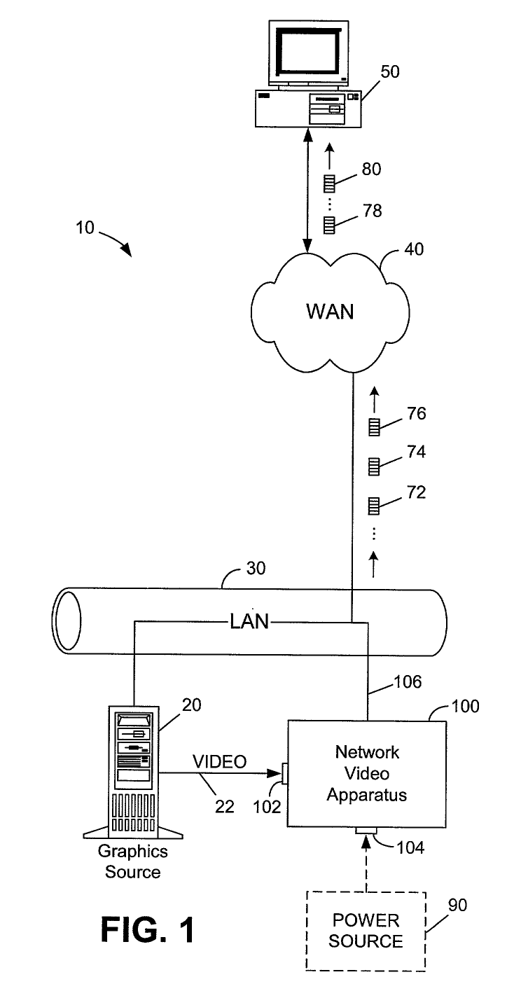

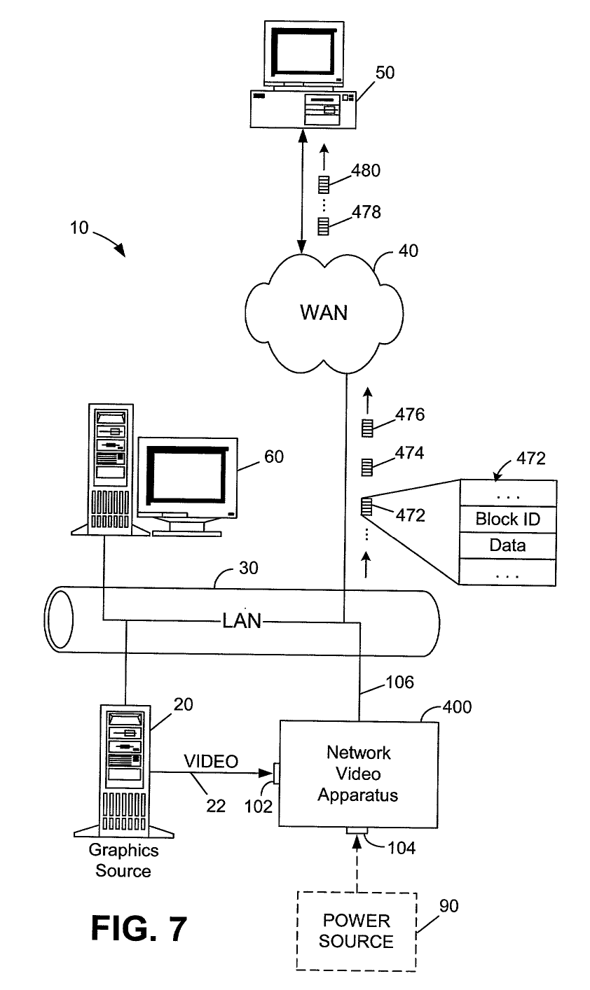

Turning now to the drawings, FIGS. 1-6 are diagrams and flowcharts illustrating certain environmental elements and features, in which the present invention may reside or operate. FIGS. 7-12 are diagrams and flowcharts that more particularly illustrate preferred embodiments of the present invention.

Reference is now made to FIG. 1, which is a diagram illustrating certain principal components of a system 10 in which the present invention may be used. More particularly, the system 10 comprises components that cooperate to communicate graphics information from a source computer 20 to a destination computer 50 across one or more networks. In the illustrated embodiment, the system 10 comprises both a local area network (LAN) 30 as well as a wide area network (WAN) 40. In many configurations, the WAN 40 will be the Internet.

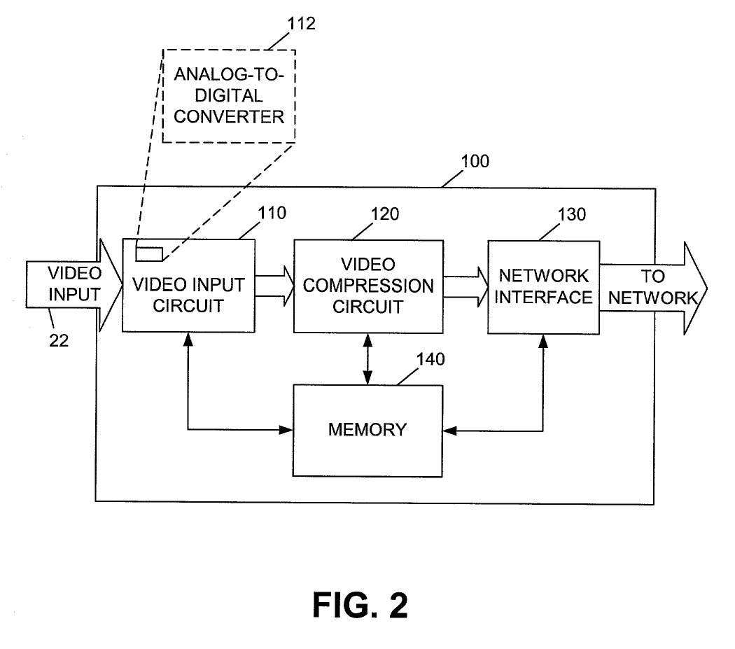

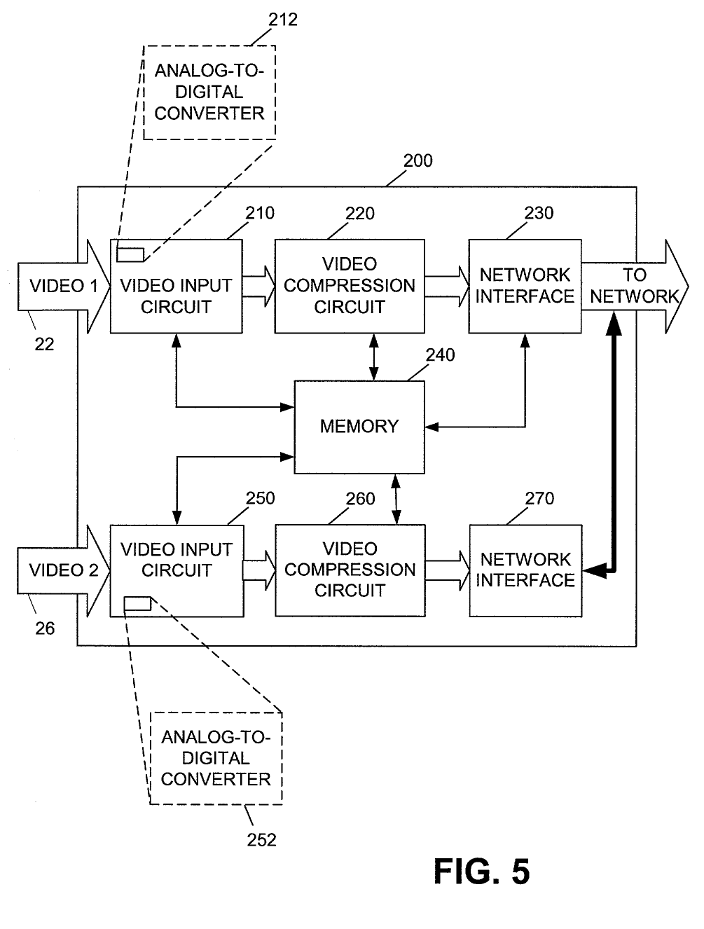

To facilitate the communication of graphics information from a source computer 20 to a destination computer 50, a novel NVA 100 is provided. Various embodiments of such a NVA 100 will be described in more detail herein (e.g., FIGS. 2 and 5). In short, the NVA 100 operates by receiving a video signal at an input, formatting the video signal for network communication, and outputting the formatted video signal across one or more networks. More particularly, a standard or conventional video signal, such as a video signal generated by a video graphics card, may be connected to the NVA 100. This connection may be made through conventional cabling 22 and a connector 102 coupled to an input of the NVA 100.

The NVA 100 may store the video signal in an internal memory. The video signal may be either a digital video signal, such as a Digital Visual Interface (DVI) compliant signal, or may be an analog video signal. If the video signal carried on cable 22 is an analog signal, then the NVA 100 will perform an appropriate analog-to-digital conversion, before storing the video signal in memory. Preferably, a compression is performed of the graphics information stored in memory, before communicating the graphics information over the networks. Such a compression can significantly reduce the amount of data that is transmitted across the networks 30 and 40. With regard to this compression, it will be appreciated that a variety of compression algorithms may be utilized.

In addition to compressing the graphics information, the NVA 100 also formats the graphics information for communication across the networks 30 and 40. In one embodiment, the graphics information is formatted into a plurality of Internet protocol (IP) packets 72, 74, 76, 78, and 80 that are communicated across the networks 30 and 40. The formatted data packets will comprise, among other things, an identification of the destination computer 50 to which the graphics information is to be transmitted. If the graphics information is transmitted in accordance with the Internet protocol, this destination identification may simply be an IP address. Since the Internet protocol is well-known, no discussion need be provided herein with regard to this protocol or the manner in which the graphics information is formatted in compliance with such a protocol. Furthermore, alternative protocols may be utilized.

Of course, as will be appreciated by persons skilled in the art, the source computer 20 will communicate to the NVA 100 the address (or other identifier) of the destination computer 50. Preferably, this communication occurs across the network 30. The source computer 20, then may send a short network communication to the NVA to inform it of the destination computer 50. Similarly, a wireless interface may also be implemented in accordance with the scope and spirit of the invention.

Alternatively, the source computer 20 may have a direct connection to the NVA 100, over which the destination information is communicated. For example, a cable may be connected between a serial port, a parallel port, a USB port, etc. of the source computer to an appropriate connector or port of the NVA 100.

Regardless of whether the destination address is communicated over the LAN 30 or through a direct connection between the source computer 20 and the NVA 100, it should be appreciated that only a minimal set of software drivers will be required to be installed on the source computer 20. It should be further appreciated that the addition and installation of the NVA to the LAN 30 will be a rather simple task.

It is presumed, for purposes of this discussion, that the destination computer 50 will comprise an appropriate network interface for receiving the data packets 72, 74, 76, 78, and 80 that carry the graphics information. It is also presumed that the destination computer 50 comprises appropriate software for evaluating the received packets and placing the collective graphics data into a frame buffer or other appropriate graphics memory for re-creating the video signal at the destination computer 50. Of course, this reconstructed video signal will drive an appropriate monitor or display (or display window). The implementation of this functionality at a destination computer is considered to be within the level of one possessing ordinary skill in the art, based upon the teachings herein, and therefore need not be described further herein.

Also illustrated in FIG. 1 is a power source 90. In one embodiment of the present invention, the NVA 100 is provided as a stand-alone appliance (as illustrated in FIG. 1). Of course, if the NVA 100 is a stand-alone appliance, then it will need to be provided power for operation. In one embodiment, this power may be provided through an internal battery. In another embodiment, this power may be provided by a standard wall outlet and a power cord connected through an appropriate connector 104 provided on the NVA 100. These features, however, are not deemed to be limitations upon the broader scope and spirit of the present invention.

Such an implementation (i.e., stand-alone) of the NVA allows for extremely convenient installation and setup. In this regard, a system in accordance with one embodiment may be set up essentially by connecting a cable between the source computer 20 and the NVA 100, and connecting the NVA 100 (via a cable 106) to the nework 30. A minimal set of appropriate software drivers may also need to be installed on the computer 20, as well as the destination computer 50.

Reference is now made to FIG. 2, which is a block diagram illustrating certain components of the NVA 100 constructed in accordance with one embodiment. As mentioned in connection with FIG. 1, the NVA 100 may be connected to the video source through a cable 22, and likewise may be connected to a LAN 30 through cabling 106. Internally, the NVA 100 may comprise a video input circuit 110. This circuit may vary from embodiment to embodiment, but will generally comprise the necessary circuit components for receiving a video signal and formatting the signal for interface with other components within the NVA 100. By way of example, if the video signal carried on cable 22 is an analog signal, then the video input circuit 110 may comprise an analog-to-digital converter 112. The video input circuit 110 may also comprise the necessary circuit components for storing discrete units of the composite video signal into a memory 140. The particular implementation of the video input circuit is not deemed to be a limitation on the scope and spirit of the present invention, and therefore is not described herein, as circuit designers or persons skilled in the art will appreciate how to design and/or implement a video input circuit consistent with the teachings herein.

In a preferred embodiment, the NVA 100 also comprises a video compression circuit 120. Functionally, the video compression circuit 120 may operate to read video data stored in the memory 140 and compress that data for more efficient communication over the networks 30 and 40. In the preferred embodiment, such a compression circuit 120 may be implemented using general-purpose hardware components, such as a digital signal processor or microprocessor, and appropriate software for controlling the operation of the hardware components. Of course, consistent with the invention, the video compression circuit 120 may be implemented using dedicated hardware or an application-specific integrated circuit (ASIC) that is specially designed for carrying out the compression function. As previously mentioned, any of a variety of compression algorithms may be utilized in connection with the invention. Indeed, certain embodiments of the present invention may not compress the video data at all, thereby eliminating the video compression circuit 120 from the NVA 100.

Finally, the NVA 100 comprises a network interface circuit 130. The network interface circuit 130 is designed to format the video data for communication over the networks 30 and 40. In this regard, the network interface circuit 130 may be configured to packetize the video data (e.g., in accordance with the Internet protocol). The network interface circuit 130 may also be configured to interface with the video compression circuit 120 and/or the memory 140. In this regard, the network interface circuit 130 may be configured to operate “on the fly,” receiving data output from the video compression circuit 120, perform the appropriate formatting of the data, and direct it to the network. Alternatively, the video compression circuit 120 may operate to compress the video data and write the compressed video data back into the memory 140. In such an embodiment, the network interface circuit 130 may be configured to read the video data from the memory 140, then format that data and direct it to the network.

Again, as mentioned above, one embodiment of the NVA 100 may be configured to transmit video data in an uncompressed format. In such embodiment, the graphics information may be directed from the video input circuit 110 directly to the network interface 130 for formatting and transmission. Alternatively, the graphics information may be directed from the video input circuit 110 to the memory 140. The network interface circuit 130 may then read data directly from the memory 140, and then format the video data for transmission. Of course, other implementations and embodiments of the NVA 100 may be readily appreciated from the discussion herein, and may be so constructed.

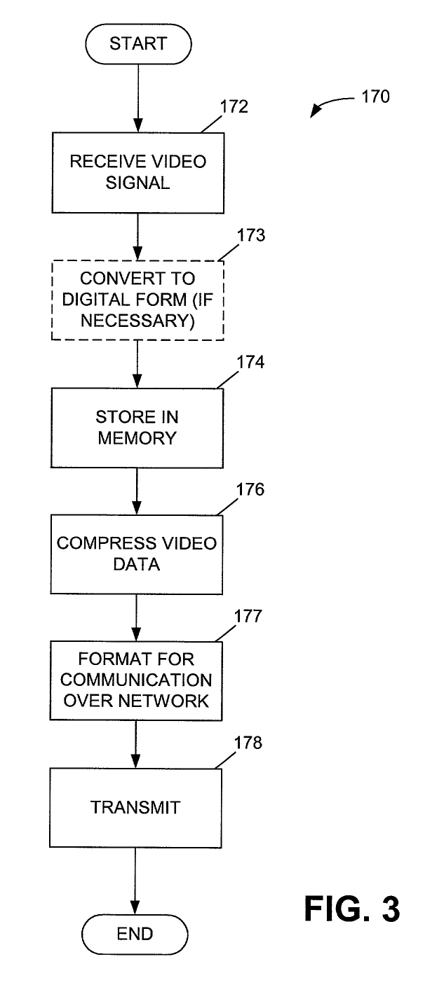

Having described the principal operation and structure of one embodiment, it should be appreciated that various methods may exist for communicating video signals from the source computer 20, across one or more networks 30 and 40 to a remote, destination computer 50. In this regard, reference is made to FIG. 3, which is a flowchart illustrating one embodiment 170 of such a method. In accordance with this illustrated embodiment, a video signal (originated by a source computer) is received at a video input (step 172). Thereafter, if the video signal is an analog signal, then it is converted into digital form (step 173). Since the step is optional, depending upon the format of the video signal, it has been illustrated in FIG. 3 in dashed outline. Thereafter, the received video signal may be stored in memory (step 174). In this regard, numerous discrete data units comprising the video signal (e.g., one frame of video) are stored in memory. In one embodiment, the stored video data is compressed using any of a variety of compression algorithms (step 176). Thereafter, the compressed video data is formatted for communication over one or more networks (step 177). Finally, the compressed video data is transmitted over the one or more networks to a remote, destination computer (step 178).

It should be appreciated that a flowchart of FIG. 3 is presented purely for purposes of illustrating one embodiment. As described herein, various alternative embodiments may be implemented as well. For example, in one embodiment the video data may not be stored in memory, but rather may be received, formatted for network communication, and communicated over the one or more networks “on the fly.” Such a real-time implementation may be realized whether the video data is compressed or uncompressed. Of course, the destination computer must be equipped with appropriate software for reconstructing the original video signal. Thus, if the source video signal is compressed prior to transmission over the network, then the appropriate decompression software and/or hardware must be resident on the destination computer. Implementation details such as these will be readily apparent and understood by persons skilled in the art, and therefore need not be described further herein.

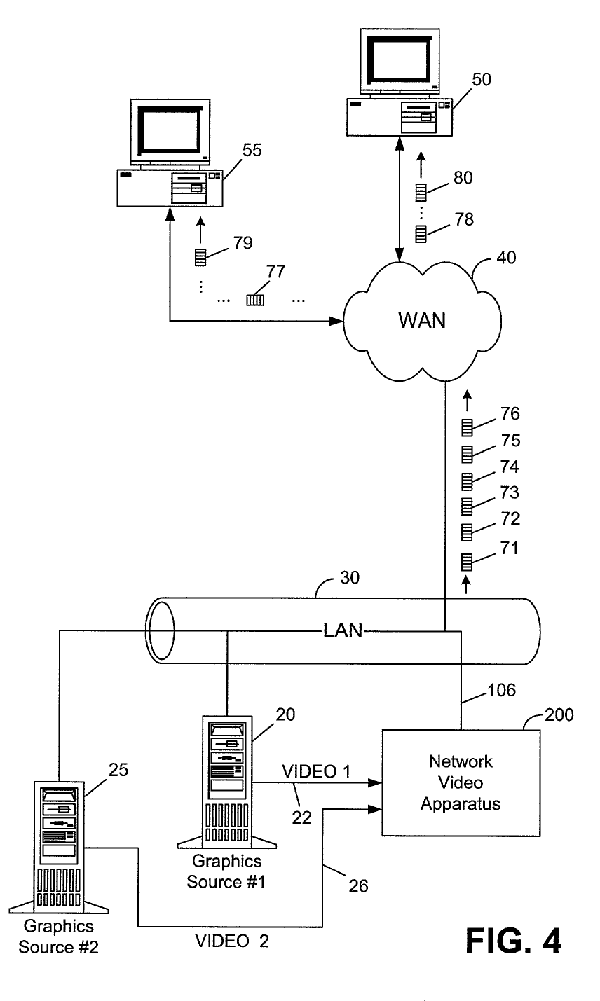

Having described the principal structure and operation of one embodiment, reference is now made to FIG. 4, which illustrates an alternative embodiment of the present invention. In short, the embodiment of FIG. 4 is similar to the embodiment illustrated in FIG. 1, except that an additional source computer 25 and an additional destination computer 55 are shown. Where appropriate, the reference numerals used in FIG. 1 have been preserved. Like the source computer 20, the second source computer 25 may be connected to the NVA 200 through conventional video cabling 26. Of course, the NVA 200 of this embodiment may comprise an additional connector or port (not shown) for receiving the additional video cable 26. Consistent with the concepts and teachings of the present invention, additional connectors or ports may be provided on the NVA 200 so that additional (not shown) graphics sources may be accommodated.

Likewise, an additional destination computer 55 may be provided. In this regard, the graphics information from the first source computer 20 may be destined for a first remote computer 50. As described in connection with FIG. 1, the NVA 200 may operate to convert the video signal carried on cable 22 into appropriate IP packets 72, 74, 76, 78, and 80 that may be communicated over the networks 30 and 40 to the remote computer 50. In similar fashion, the NVA 200 may operate to convert the video signal carried on cable 26 into appropriate IP packets 71, 73, 75, 77, and 79 that may be communicated over networks 30 and 40 to the remote computer 55. Upon receiving these packets, remote computer 55 may be configured to reconstruct the original video image embodied in the video signal carried on cable 26. This video image reconstruction may operate as previously described in connection with the destination computer 50.

Reference is now made briefly to FIG. 5, which is a block diagram similar to the diagram of FIG. 2, which illustrates certain principal components that may be provided within the NVA 200. As described in connection with FIG. 2, a video input circuit 210 is provided to receive the video signal carried on cable 22. If appropriate, the video input circuit 210 may comprise an analog additional converter 212, which may operate to convert an analog video signal into digital values. The video compression circuit 220, network interface 230, and memory 240 may also be provided and configured to operate like the corresponding components described in FIG. 2.

In addition, a second video input circuit 250 may be provided and configured to receive the video signal carried on cable 26. Like the video input circuit 210, the video input circuit 250 may comprise an analog-to-digital converter 252. Also, a second video compression circuit 260 and a second network interface 270 may also be provided within NVA 200. The function or operation of these components will be similar to the video input circuit 110, video compression circuit 120, and network interface circuit 130, that were described in connection with FIG. 2. It will be appreciated that, although these components have been illustrated separately for purposes of simplifying the discussion herein, the actual implementation may be designed so that certain components are shared. For example, the NVA 200 may be designed with a single network interface circuit that is designed and configured with the remainder of the circuitry to handle network communications for both video streams.

Although not explicitly shown in FIG. 5, it should be appreciated that additional components may be comprised within the NVA 200 to accommodate additional video streams.

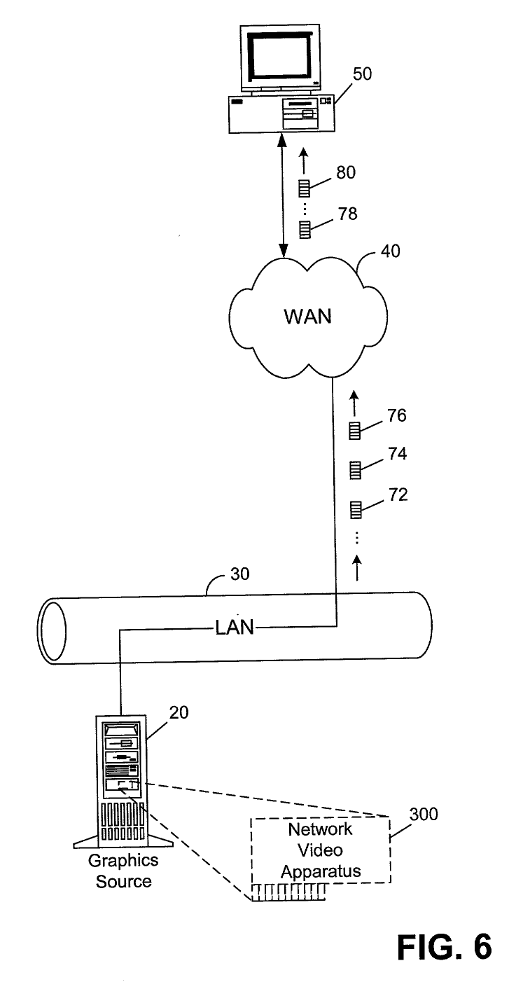

Reference is now made to FIG. 6, which is a diagram similar to the diagram of FIG. 1, but illustrating yet another embodiment. Where appropriate, the reference numerals used in FIG. 1 have been preserved. As illustrated in FIG. 6, rather than providing the NVA 100 or 200 as a separate or stand-alone device, it may be integrated within the computer 20 containing the graphics source. In this regard, the NVA 300 may be provided on a circuit card that may be plugged directly into, for example, a motherboard of the computer 20. In such an embodiment, the NVA 300 may utilize a network interface provided as a part of computer 20 (or a network card that may be plugged into the computer—e.g., an Ethernet card). In this way, separate network connections between the NVA 300 in the network 30 may not be required. In addition, the NVA 300 could receive its power supply signals directly from the power supply of the computer 20. However, it will be appreciated that an embodiment such as that illustrated in FIG. 6 may require additional software drivers to be installed on the computer 20 to appropriately recognize and/or configure the circuit card 300. Aside from these differences, the structure and operation of the circuitry provided on the NVA 300 may be substantially the same as that described in connection with NVA 100 and 200.

From the foregoing discussion, it should be appreciated that certain embodiments provide a NVA 100, 200, or 300 that is attached to the video output of a graphics adapter on a source computer node. FIGS. 1, 4, and 6 show diagrams of how the invention could be used in a network topology. The NVA may compress and convert the video output into a sequence of IP (Internet Protocol) packets or some other network protocol.

The video output may be a digital signal as in DVI, or it may be an analog video signal. The IP packets may be sent to a destination computer node on the network. The destination computer node 50 may receive the IP packets from the NVA 100, 200, or 300, decompress them, assemble the image, and then display the results in a window on a display device of the computer 50. The decompression, assembly, and display of the image can be implemented in a software client written as a JAVA program, JAVA applet, native implementation, or some other method running on the destination computer node 50, consistent with the invention. The software client may optionally control the NVA 100, 200, or 300 by configuring the refresh rate, window size on the destination computer node 50, or other parameters. Additional hardware to assist in this process may also be used on the destination computer node 50. Such additional hardware will be understood by persons skilled in the art from the teachings provided herein, and need not be described further.

Another way to think about this is, instead of a monitor being attached to the video output of the source computer node 20, an RGB-to-IP (red green blue-to-IP) converter may be attached (of course both may be attached to receive the same video signal). This converter (e.g., the NVA 100, 200, or 300) can compress and transmit the output to one or more destination IP addresses. In one embodiment, the NVA may be configured to transmit the same graphics information to a plurality of destination computers.

The NVA 100, 200, or 300 may comprise one or more video input ports, either analog or digital, one or more DSPs or similar low-cost, high-performance embedded controller, CPU or custom chip, one or more Ethernet ports or similar network interface ports, RAM, and other miscellaneous parts. The video input port is connected to a video output of the graphics port on the source computer node 20. The CPU or DSP preferably compresses the video signal and encapsulates the data in IP or other network protocol. The packets are then sent out the network interface port. The appliance may comprise other ports such as RS-232 or power. As should be appreciated by persons skilled in the art, the CPU or DSP could also be a field programmable gate array (FPGA), an application specific integrated circuit (ASIC), an embedded CPU, or some combination or variant of such devices.

It will be appreciated from the foregoing that numerous advantages are realized by the system that has been described herein through several embodiments. One such advantage is platform independence. No low-level OS or device driver changes are required on the source computer node 20. Indeed, the system described herein is OS-independent and hardware-independent.

Another advantage is that no additional computational overhead on the source computer node 20 is required. As is known, certain traditional techniques involve significant computation in the color space coalescing conversion (e.g., the application of color look-up tables to window IDs) and compression stage. These significant computations are avoided in the system described herein.

The embodiments described herein should not be construed as limiting on the system, but rather should be construed as illustrative. Indeed, numerous variations of the embodiments specifically described herein may be implemented, consistent with the scope and spirit of the invention. For example, the functionality embodied in the NVA described herein may be integrated onto a graphics adapter either using a separate chip or within the graphics chip itself. One place where this may be implemented is the point that the random access memory digital-to-analog converter (RAMDAC) is traditionally located in a graphics chip.

Alternatively, the functionality embodied in the NVA may be integrated onto a peripheral component interface (PCI) based board that plugs into the source computer node. This would simplify the power requirements for the apparatus. The PCI board could accept video input from the video output of the graphics device. A DSP, FPGA, or ASIC on the PCI board would compress and convert the data to some IP-based protocol. The IP would be sent on a network interface port.

In yet another embodiment, the functionality embodied in the NVA may be embodied into a block of code, such as Verilog, and sold to a graphics chip design company to be implemented in the graphics adapters.

Having described various operating environments in which the present invention may reside, reference will now be made to preferred embodiments of the present invention. In this regard, and as summarized above, the present invention is directed to a system and method for communicating graphics information from a source computer to one or more destination computers over a network. One distinct advantage of the present invention is that the communication of graphics information is bandwidth efficient, in that the preferred embodiment is configured to transmit only the portions of the graphics information that change in subsequent video frames (after a first video frame has been communicated). For purposes of simplifying the discussion herein, to best illustrate the inventive aspects of the preferred embodiment, the discussion will assume that an entire frame of video information from a previous frame has been stored in a frame buffer memory. It should be appreciated, however, that consistent with the scope and spirit of the invention, only a portion (e.g., a Window) of a video frame may be stored. For example, perhaps only a Window of information is stored. This Window, as in the case of an entire frame, may be partitioned into tiled, which are compared against corresponding tiles of previous frames. Implementation of such an embodiment will be appreciated by persons skilled in the art, and need not be separately described herein.

In the illustrations and description of the preferred embodiments that follow, certain components and features described in connection with FIGS. 1-6 may be omitted for purposes of simplifying the description and emphasizing certain components that are unique to the preferred embodiments. However, it should be appreciated by persons skilled in the art that the steps or components described below will preferably be integrated into an operating environment similar to that described in connection with FIGS. 1-6.

Reference is now made to FIG. 7, which is a system-level block diagram similar to the diagram of FIG. 1. Indeed, the reference numerals used to denote the various system components in FIG. 1 have generally been preserved in FIG. 7, where appropriate. However, the NVA 400 of FIG. 7 is preferably configured to operate differently than the corresponding NVA 100 illustrated in FIG. 1. Like the NVA 100 of FIG. 1, the NVA 400 is preferably configured to receive a first frame of graphics information, compress and packetize that frame of graphics information, and transmit the packets 472, 474, 476, 478 and 480 to a destination computer 50. The NVA 400 is preferably configured to achieve extremely efficient bandwidth utilization for the transmission of graphics information of subsequent video frames.

In this regard, the NVA 400 is preferably configured to evaluate a plurality of discrete portions (or blocks) of each video frame, and compare each portion with the corresponding portion of the previous video frame. If the NVA 400 determines that there is no change in a given portion of a video frame, then that portion need not be transmitted to the remote computer 50. Instead, the NVA 400 is preferably configured to compress and transmit graphics information of only those portions of the video frame that have changed since the previous video frame. In one embodiment, each video frame may be effectively partitioned into 16,384 blocks. As mapped to a video screen, these blocks may comprise an array of 128 blocks by 128 blocks. In a common display system having a resolution of 1,280 pixels by 1,024 pixels, each block has a corresponding resolution of 10 pixels by 8 pixels. Consistent with the scope and spirit of the present invention, however, a number of different block sizes may be chosen based upon system resources, the nature of the graphics information to be transmitted, and other factors. Indeed, consistent with the invention, the NVA 400 may be configured to dynamically vary the block size, depending upon the number of blocks that are observed to have changing video data from frame to frame. It will be appreciated that, for most video applications, a tremendous amount of bandwidth savings is achieved by the present invention. It will be further appreciated that, consistent with the scope and spirit of the invention, multiple blocks may be combined together to form a larger region, which could be compressed.

As is also illustrated in FIG. 7, the packets 472, 474, 476, 478, and 480 will preferably differ from the corresponding packets illustrated in FIG. 1. In this regard, the packets of data transmitted by the NVA 400 of the preferred embodiment preferably comprise an identification of the block (e.g., block number) within the video frame (as well as the corresponding data) that is being transmitted, as this information will be utilized by the destination computer 50 for updating its display. It should be further appreciated that a given packet (e.g. packet 472) may contain an entire block of video data, multiple blocks of video data, or only a portion of a block of video data. In this regard, the communication over the network 40 is preferably transmitted in accordance with the Internet Protocol.

Of course, numerous implementation details have not been described herein. For example, in one embodiment, it may be desired to periodically retransmit an entire frame buffer, in the event that packets have been lost during transmission, or if the frame buffer memories from the NVA 400 and the destination computer 50 have become unsynchronized. It may likewise be desired to retransmit an entire frame buffer if a large amount of the display has changed from the previous screen, or if a certain change threshold has been reached. In such a situation, it may be more efficient to compress the entire display than to compress and transmit each block independently. In another embodiment, the destination computer may be configured to transmit acknowledgements back to the NVA 400, to better ensure proper synchronization between the two.

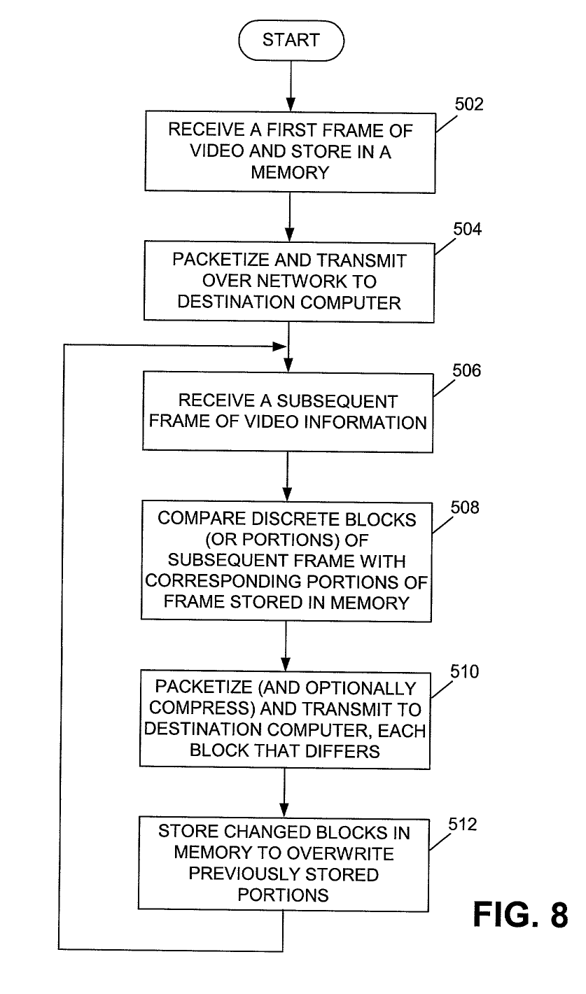

Having described an aspect of the preferred embodiment, reference is now made to FIG. 8, which is a flowchart illustrating the top-level functional operation of the NVA 400. In this regard, the NVA 400 is preferably configured to receive a first frame of graphics information from the source computer 20 and store that graphics information in a memory. This graphics information is “grabbed” from the video port of a graphics card, which information is generated by the display refresh unit of the computer graphics card.

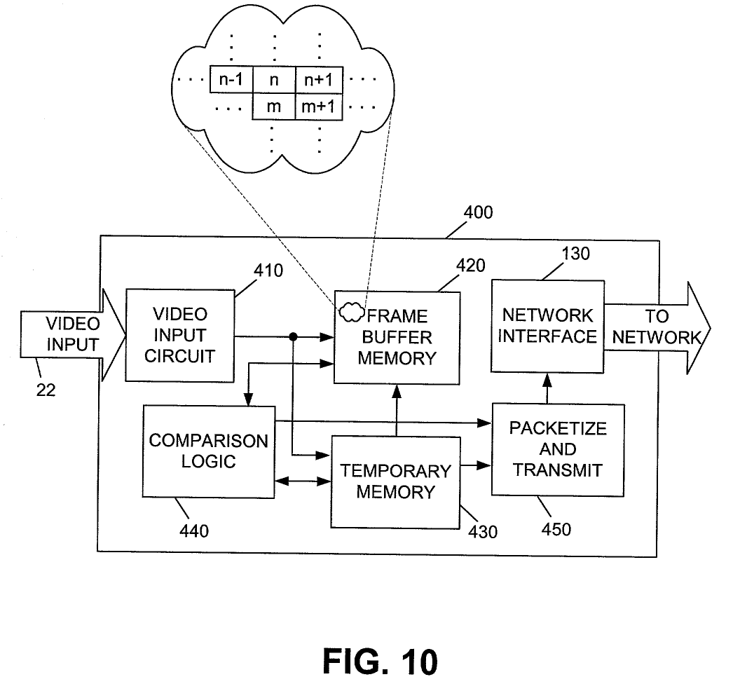

In keeping with the description of FIG. 8, the NVA 400 receives a first full frame of graphics information and stores it in an internal memory (step 502). This full frame of graphics information is preferably compressed (compression logic illustrated in FIGS. 2 and 5), packetized, and transmitted over the network 40 to the destination computer(s) 50 (step 504). Thereafter, the NVA 400 receives a subsequent frame of graphics information (step 506). In one embodiment, this subsequent frame of graphics information is stored in a temporary memory 430 (see FIG. 10). The NVA 400 is then configured to compare discrete portions or blocks of the frame of graphics information stored in the temporary memory 430 with the corresponding portions or blocks of the graphics information stored in the memory 420 (step 508). For each portion or block of the video frame that is identified to be different from the corresponding portion or block in the frame buffer memory 420, the NVA packetizes and transmits that block to the destination computer (step 510).

In this regard, and depending upon the particular application, the NVA 400 may be configured to transmit each block of graphics information, if it is determined that any change at all exists from the previously stored block. In certain embodiments, however, it may be desirable to set some threshold of change. Specifically, the NVA 400 may be configured to evaluate the degree or amount in which a current block has changed from a previously stored block, and transmit the current block only if the graphics information has changed by some predetermined amount. The implementation of such an embodiment will vary from application to application and be predicated upon design constraints and objectives. Finally, the NVA 400 is configured to overwrite blocks within the frame buffer memory 400 with corresponding blocks stored in the temporary memory 430 that reflect or embody a change in the graphics information (step 512). In an alternative embodiment, the NVA 400 may be configured to simply overwrite the entire frame buffer memory 420 with the contents of the temporary memory 430. However, such an approach may not be preferred as it would require additional bus transactions for the transfer of duplicative data from the temporary memory 430 to the frame buffer memory 420. As previously mentioned, multiple blocks could be combined together into a larger region that could be compressed.

It should be appreciated that, consistent with the scope and spirit of the present invention, there are a variety of way to implement the manner in which successive video frames are stored, compared, and overwritten. In addition to the other manners described herein, one alternative approach is to “grab” the current frame and compare it to previous the stored frame, and classify individual blocks or tiles as either changed or not changed. After processing the current frame, the current frame then becomes the stored (or previous) frame and the previous frame becomes the current frame. Under this approach, the current frame does not have to be copied from a temporary buffer to a “previous” buffer.

The logic to implement this may be described as:

for all incoming pixels

store pixel into current buffer

for all pixels

compare previous buffer against current buffer and classify

for all tiles that have changes

compress tile

transmit compressed tile

swap buffers

An alternative approach may be to compare the blocks or tiles of the previous frame with the current frame, as the current frame is grabbed. This approach may be described as:

for all incoming pixels

Store pixel into current buffer

compare current pixel against previous pixel

classify tile

for all tiles that have changed

compress tile

transmit compressed tile

swap buffers

Other ways for implementing this comparison feature will be appreciated by persons skilled in the art, and need not be described herein, as the present invention is not limited to any particular manner or methodology of implementing this feature.

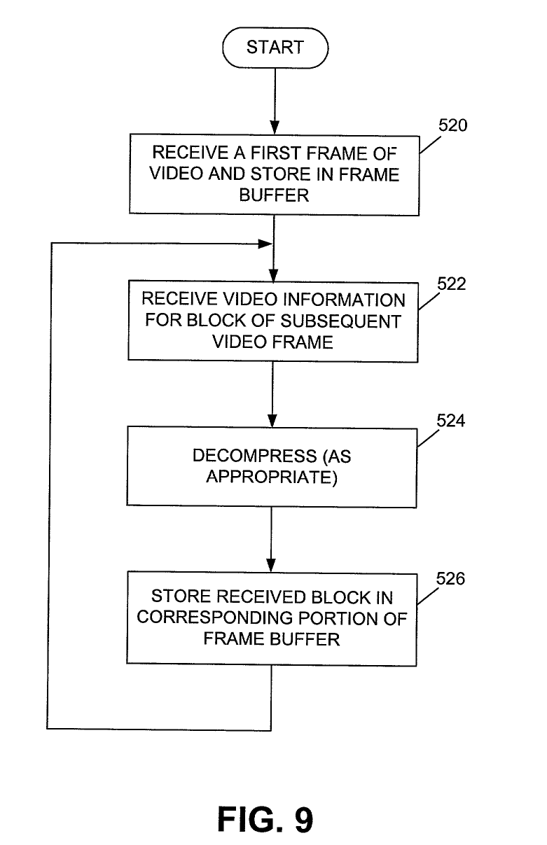

Having described the top-level functional operation of the NVA 400 of the preferred embodiment, reference is now made to FIG. 9, which is a flowchart illustrating the top-level functional operation of a destination (or client) computer 50. In operation, a destination computer 50 is configured to receive a first full frame of graphics information and store that graphics information in the frame buffer of the graphics cards (step 520). In this regard, it will be assumed that the destination computer 50 is configured with the appropriate software drivers for interfacing between the components of the present invention and the graphics card installed in the destination computer 50. In a conventional manner, the graphics card on the destination computer 50 will retrieve information from the frame buffer on the graphics card and render that graphics information on a display. As the inventive components of the system of the present invention continued to update the frame buffer of the graphics card, the graphics card of the destination computer 50 will continue to accordingly update the display. Therefore, upon receipt of a first frame of graphics information by the destination computer, the destination computer will be configured to thereafter receive graphics information for portions or blocks of subsequent video frames (step 522). These blocks of subsequent graphics information are decompressed (step 524) in accordance with an appropriate algorithm (i.e., a decompression algorithm that is reciprocal to the compression embodied by the NVA 400). Thereafter, the destination computer 50 is configured to override the frame buffer blocks or portions that correspond to the received frame buffer blocks or portions. As the graphics card installed in the destination computer 50, in accordance with its conventional operation, continues to render data from the frame buffer to the display screen, this changed data will automatically and continually be reflected on the display.

Reference is now made to FIG. 10, which is a block diagram illustrating certain principle components of the preferred embodiment of the NVA 400. The NVA 400 may comprise a video input circuit 410 that is configured to receive video input on cable 22, digitize the graphics information if appropriate, and appropriately store a first frame of graphics information into a frame buffer memory 420. As previously mentioned, the frame buffer memory 420 may be configured to mimic the organization of a conventional frame buffer memory as contained on a graphics card. The video input circuit 410 will preferably comprise the appropriate circuitry and/or software logic for identifying the start of a video frame and capturing the appropriate information for storing within the frame buffer memory 420.

As previously described, in accordance with the preferred embodiment of the invention, the frame buffer memory 420 is effectively partitioned into a plurality of blocks that are separately and individually analyzed and updated with corresponding blocks of subsequent video frames. In this respect, the NVA 400 preferably comprises a temporary memory 430 in which a current video frame (i.e., a subsequent video frame, after the first video frame is received and stored in the frame buffer memory 420) is temporarily stored. The NVA 400 further comprises comparison logic for comparing blocks stored within the temporary memory 430 with corresponding blocks stored within the frame buffer memory 420. The comparison logic 440 may be implemented in hardware, software, or an appropriate combination of the two, depending upon design constraints and objectives. In operation, the comparison logic 440 may be configured to identify those blocks of graphics information that differ from the corresponding blocks stored in the frame buffer memory 420, and forward those blocks for transmission to the destination computer 50. For each block of graphics information that is identified by the comparison logic 440 to have changed, the comparison logic 440 may be further configured to overwrite the corresponding block of the frame buffer memory 420 with the new, or changed, graphics information.

Finally, FIG. 10 illustrates a functional block 450 labeled as “packetize and transmit.” This block functions to receive the changed graphics information from the comparison logic 440, packetize that information, and transmit the information over the network 40 to the destination computer 50. In this respect, block 450 is preferably configured to compress each block of graphics information before transmission, in order to minimize bandwidth consumption over the network 40.

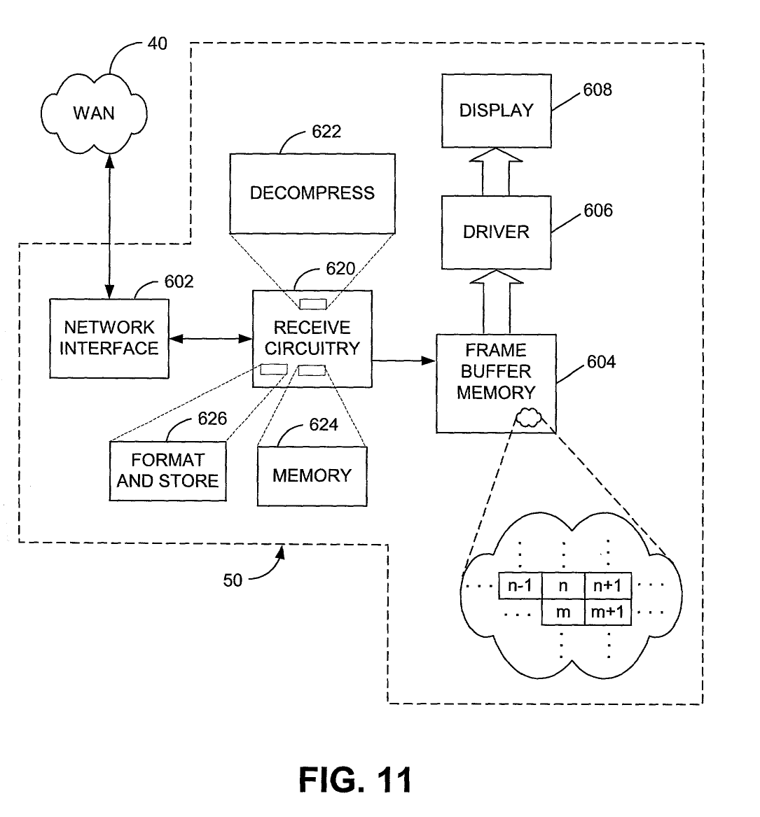

Reference is now made to FIG. 11, which is a block diagram illustrating certain components within the destination computer 50. Several of the components illustrated in FIG. 11, such as the network interface 602, frame buffer memory 604, video driver 606, and display 608 are conventional components, and need not be described herein. In this respect, the network interface 602 may be provided in connection with an Ethernet card or other conventional network interface that are well-known. The network interface 602 is configured to receive data transmitted over the network 40. Likewise, the frame buffer memory 604 may be provided on a graphics card installed within the destination computer 50. Likewise, the video driver 606 and display 608 may be conventional components of the graphics and display system of the destination computer 50.

With respect to the inventive components, the destination computer 50 may comprise receive circuitry 620, which is configured to receive graphics information from the network interface 602 (i.e., the graphics information transmitted by the NVA 400). The receive circuitry 620 may comprise logic 622 for decompressing graphics information, if the NVA 400 is configured to first compress information before transmission over the network. Similarly, the receive circuitry 620 may comprise a memory 624 for temporarily storing graphics information received from the network. In operation, the receive circuitry 620 will overwrite information stored within the frame buffer memory 604 with new graphics information that is received over the network 40. In this regard, the receive circuitry 620 may receive an entire frame of graphics information that it correspondingly writes into the frame buffer memory 604. Alternatively, the receive circuitry 620 may receive only blocks of graphics information that it writes into corresponding locations of the frame buffer memory 604.

As previously described, the NVA 400 of the preferred embodiment organizes packets of data transmitted over the network to identify, if appropriate, particular blocks of the frame buffer to which the data corresponds. The receive circuitry 620 will, accordingly, be configured to identify such block descriptors and write the received information into the appropriate location of the frame buffer 604. If an entire frame of graphics information is transmitted from the NVA 400 to the destination computer 50, the receive circuitry may be configured to readily receive and overwrite the entire frame buffer 604 with the frame of graphics information. Alternatively, if only particular blocks of graphics information are transmitted from the NVA 400 to the destination computer 50, the receive circuitry 620 is configured to overwrite only those corresponding blocks.

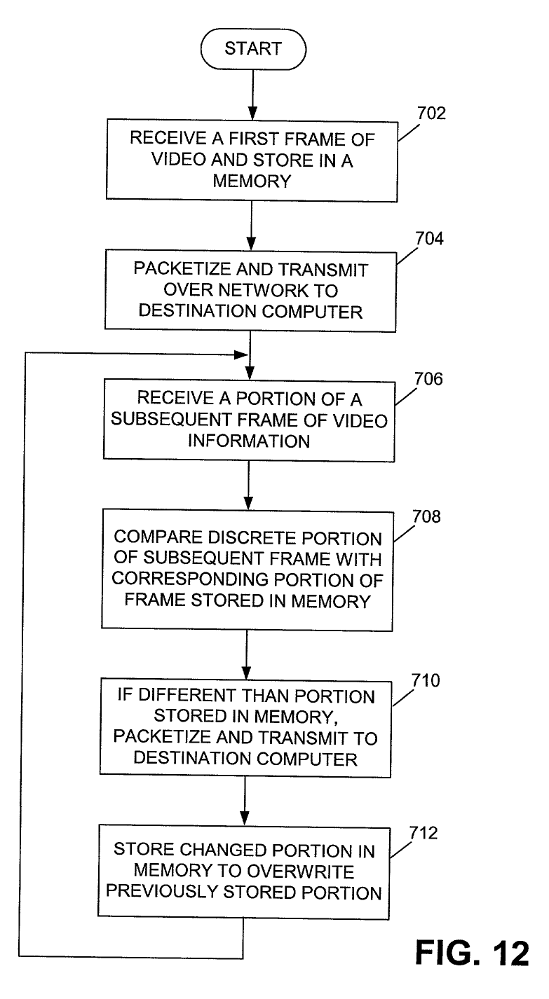

Having described the structure and operation of the preferred embodiment of the present invention, it will be appreciated that a variety of alternative embodiments may be provided within the scope and spirit of the present invention. In this regard, reference is made briefly to FIG. 12, which is a flowchart illustrating the top-level operation of the NVA 400 constructed in accordance with one such alternative embodiment. In this regard, the NVA 400 may be constructed to evaluate individual blocks of graphics information as they are received from the source computer 20, without first receiving an entire frame of subsequent graphics information. Such an alternative configuration would advantageously reduce the size of the temporary memory 430 (see FIG. 10). In operation, such an embodiment would, like the previously described embodiment, receive a first full frame of graphics information and store that frame into the frame buffer memory 420 (step 702). That first full frame of graphics information would then be packetized and transmitted over the network (step 704), as previously described. Thereafter, the NVA 400 may be configured to evaluate the graphics information “on the fly” as it is received from the source computer 20.

Specifically, the NVA may be configured to receive a portion of the graphics information (706) and compare the received portion with a corresponding portion, or block, stored in the frame buffer memory 420 (step 708). If this portion is different than the previously stored portion, the NVA 400 may be configured to packetize and transmit this portion over the network 40 to the destination computer 50 (step 710). Finally, and if this portion of the video frame differed from the corresponding portion stored in the frame buffer memory 420, the NVA 400 may be configured to overwrite the corresponding memory portion of frame buffer memory 420 with the newly-received portion of graphics information (step 712). This process is repeated for all portions of a current video frame, and cyclically repeated for subsequent video frames.

Although various alternative implementations may be implemented within the scope and spirit of the present invention based upon the foregoing description, the following is a pseudo-code algorithm of one implementation at the NVA:

1. For each video refresh by the graphics card within the source computer, the NVA 400:

a. Reads the current video frame into memory for the current video frame from a video port;

b. For each block in the video frame;

i. Compare the block in the current video frame against the corresponding block in the previous video frame;

ii. If the current block is different from the previous block, then;

1. The NVA compresses the block in the current video frame;

2. The NVA transmits the block to the destination computer over the network;

iii. The current video frame is now made the previous video frame.

Likewise, the following is a pseudo-code algorithm of one implementation of the operation of the destination computer;

1. For each transmitted video frame by the NVA;

a. For each transmitted block in the video frame;

i. Read the blocks from the network interface;

ii. Decompress the blocks;

iii. Assemble one or more images to be displayed; and

iv. Display the blocks at the correct location on the screen.

What is claimed is:

1. An apparatus for communicating graphics across a network comprising:
a frame buffer memory for storing and maintaining at least a portion of a previous frame of graphics information, the graphics information being contained in a video signal;
a temporary memory configured to store at least a portion of a current frame of graphics information;
comparison logic for comparing a portion of the current frame of graphics information with a corresponding portion of the previous frame; and
transmission logic for transmitting the portion of the current frame to a destination computer, if the comparison logic determines that the portion of the current frame of graphics information differs from the corresponding portion of the previous frame by more than a predetermined measure.

2. The apparatus of claim 1, wherein the frame buffer memory is configured to store an entire frame of graphics information.

3. The apparatus of claim 1, wherein the predetermined measure is any quantifiable difference.

4. The apparatus of claim 1, wherein the video signal is an analog video signal.

5. The apparatus of claim 1, further comprising compression logic for compressing the portion of the current frame before transmission.

6. The apparatus of claim 1, further comprising a network interface circuit coupled to both the transmission logic and the network, the network interface circuit configured to format and communicate the graphics information over the network to a remote computer.

7. The apparatus of claim 1, wherein the network comprises a local area network (LAN).

8. The apparatus of claim 1, wherein the network comprises a wide area network (WAN).

9. The apparatus of claim 1, wherein the network interface circuit is configured to format the graphics information into a plurality of Internet Protocol (IP) packets that are communicated over the computer network to the remote computer.

10. The apparatus of claim 1, further comprising a second input for receiving a second video signal.

11. The apparatus of claim 10, further comprising a second frame buffer memory for storing and maintaining a previous frame of graphics information from the second video signal.

12. The apparatus of claim 10, further comprising a second temporary memory configured to store at least a portion of a current frame of graphics information from the second video signal.

13. The apparatus of claim 1, wherein temporary memory is configured to store an entire frame of the current frame of graphics information

14. An apparatus for displaying graphics information received from a remote computer and communicated across a network comprising:
an input for receiving packetized graphics information; and
input logic configured to format and store a portion of a frame of graphics information received at the input into an appropriate location of a frame buffer memory, the portion being an amount less than the whole frame buffer.

15. The apparatus of claim 14, wherein the input logic further comprises logic configured to decompress received graphics information.

16. A method for communicating graphics across a computer network comprising:
storing at least a portion of a frame of graphics information obtained from a video signal;
receiving at least a portion of a current frame of graphics information;
comparing a portion of the current frame of graphics information with a corresponding portion of the stored frame of graphics information;
if the compared portion of the current frame of graphics information differs by at least a predetermined amount from the corresponding portion of the stored graphics information, then transmitting the compared portion of the current frame of graphics information to a destination computer; and
if the compared portion of the current frame of graphics information differs by at least a predetermined amount from the corresponding portion of the stored graphics information, then overwriting the corresponding portion of the stored graphics information with the compared portion of the current frame of graphics information.

17. The method of claim 16, wherein the step of receiving at least a portion of the current frame of graphics information more specifically comprises receiving an entire frame of graphics information.

18. The method of claim 16, further comprising compressing the compared portion of the current frame of graphics information before transmitting to the destination computer.

19. The method of claim 16, wherein the predetermined measure is any quantifiable difference.
